(19) United States
(12) Patent Application Publication
(10) Pub. No.: US 2024/0151430 A1
(43) Pub. Date: May 9, 2024

(54) APPARATUS AND METHOD FOR PASTEURIZING OR STERILIZING LIQUIDS

(71) Applicant: Global Water Purification, LLC, Grovetown, GA (US)

(72) Inventors: David Byrne, Grovetown, GA (US); Terrance John Byrne, Grovetown, GA (US)

(73) Assignee: Global Water Purification, LLC, Grovetown, GA (US)

(21) Appl. No.: 18/053,731

(22) Filed: Nov. 8, 2022

(51) Int. Cl. F24H 1/16

(52) U.S. Cl. CPC F24H 1/16; A23L 3/22

(57) ABSTRACT

A heat exchanger and method of operating a heat exchanger provides a compact and scalable device for pasteurizing or sterilization a liquid. The heat exchanger includes a container and a tube that extends from an opening in the container to the interior volume of the container. The Heat exchanger also includes a liquid level sensor, a temperature sensor, and one or more flow elements, such as a pump or a valve. A controller is programmed to operate the heat exchanger in a manner that provides pasteurized or sterilized liquids from the heat exchanger.

### BACKGROUND OF THE INVENTION

### Field of the Invention

The present invention generally relates to heating liquids, and more specifically to an apparatus and method for pasteurizing or sterilizing liquids.

### Discussion of the Background

The need for safe drinking water for people is well understood, but is not available for a variety of reasons. Thus, for example, many water supplies are contaminated with pathogens, such as those from fecal matter. While developed countries typically have sophisticated water treatment plants, many developing countries lack the ability to provide safe water. One reason for the lack of safe water is the lack of water infrastructure for treating and delivering safe water. In general, there is a lack of simple, scalable devices for treating water.

Thus, there is a need in the art for an apparatus and method that permits for small-scale treating of pathogen-containing water. Such an apparatus should be able to pasteurize or sterilize liquids including, but not limited to, water, milk, fruit juices, waste-water, human and animal waste, and any liquified fluids that may have pathogens within them. Such apparatus should be easy to manufacture and simple and inexpensive to operate.

### BRIEF SUMMARY OF THE INVENTION

The present invention overcomes the disadvantages of prior art by providing a heat exchanger and method that is compact and which utilizes a unique heat exchanger design.

It is one aspect to provide a heat exchanger having an inlet to accept a fluid and an outlet to provide a processed fluid. The heat exchanger includes a container, a tube disposed within the container, a heating element disposed in the container, and a temperature sensor to measure the temperature of fluid within the tube or within the container. The container defines an exterior and an interior, where the container includes a first opening through the container and a second opening through the container, where one of the first opening or the second opening is the fluid inlet and where the other opening of the first opening and second opening is the fluid outlet. The tube has a first end and a second end, where the first end is attached to the first opening, and where the second end is within the interior of the container. When fluid inlet is provided with the fluid, the fluid flows through the tube, through the interior of the container, and through the fluid outlet.

It is another aspect to provide a heat exchanger having an inlet to accept a fluid and an outlet to provide a processed fluid. The heat exchanger includes: a container having a wall defining an exterior and an interior, where the container includes a first opening through the wall and a second opening through the wall, where one of the first opening or the second opening is the inlet and where the other opening of the first opening and second opening is the outlet; a tube having a first end and a second end, where the first end is attached to the wall at the first opening, and where the second end is within the interior of the container; a heating element disposed in the container, and a temperature sensor to measure the temperature of fluid within the tube or within the container, where, when fluid inlet is provided with pressurized fluid, the fluid flows through the tube and through the interior. The heat exchanger further includes: one or more flow elements to control the flow of accepted fluid through the heat exchanger; a liquid level sensor, and a controller including a processor and memory and programmed to operate the one or more flow elements and the heating element in response to measurements of the temperature sensor and liquid level sensor.

It is yet another aspect to provide a heat exchanger were where the one or more flow elements include a first pump to pressurize fluid entering the container at the fluid inlet and/or a second pump to provide suction to at the fluid outlet, or where the accepted fluid is pressurized and where the one or more flow elements include one or more valves controllable to permit the pressurized fluid to flow through the heat exchanger.

It is another aspect to provide a heat exchanger with a container for heating a fluid including a temperature sensor and a heating element are disposed near the top of the container.

It is one aspect to provide a heat exchanger with a container for heating a fluid including a temperature sensor and a heating element are disposed near the bottom of the container.

It is one aspect to provide a method of controlling a heat exchanger having a fluid inlet to accept a fluid and a fluid outlet to provide a processed fluid, where the heat exchanger includes: a container defining an exterior and an interior, where the container includes a first opening through the container and a second opening through the container, where one of the first opening or the second opening is the fluid inlet and where the other opening of the first opening and second opening is the fluid outlet; a tube disposed within the container, where the tube has a first end and a second end, where the first end is attached to the first opening, and where the second end is within the interior of the container; a heating element disposed in the container, and a temperature sensor to measure the temperature of fluid within the tube or within the container, where the heat exchanger further includes a controller including a processor and memory, where the processor is programmed to operate the one or more flow elements and the heating element in response to measurements of the temperature sensor and liquid level sensor.

These features together with the various ancillary provisions and features which will become apparent to those skilled in the art from the following detailed description, are attained by the heat exchanger of the present invention, preferred embodiments thereof being shown with reference to the accompanying drawings, by way of example only, wherein:

### BRIEF DESCRIPTION OF THE SEVERAL VIEWS OF THE DRAWING

FIG. 1 is a top view of the heat exchanger of the present invention;

FIG. 2A is a sectional view 2A-2A of certain embodiments of the heat exchanger of FIG. 1;

FIG. 2B is a sectional view 2B-2B of certain other embodiments of the heat exchanger of FIG. 1;

FIG. 3 is a perspective and sectional exploded view of the heat exchanger of FIG. 1;

FIG. 4 is a first embodiment operation of the heat exchanger of FIG. 2A with the first opening being a liquid inlet and the second opening being a liquid outlet;

FIG. 5 is a second embodiment operation of the heat exchanger of FIG. 2A with the second opening being a liquid inlet and the first opening being a liquid outlet;

FIG. 6 is a third embodiment operation of the heat exchanger of FIG. 2B with the first opening being a liquid inlet and the second opening being a liquid outlet; and

FIG. 7 is a fourth embodiment operation of the heat exchanger of FIG. 2B with the second opening being a liquid inlet and the first opening being a liquid outlet.

Reference symbols are used in the Figures to indicate certain components, aspects or features shown therein, with reference symbols common to more than one Figure indicating like components, aspects or features shown therein.

### DETAILED DESCRIPTION OF THE INVENTION

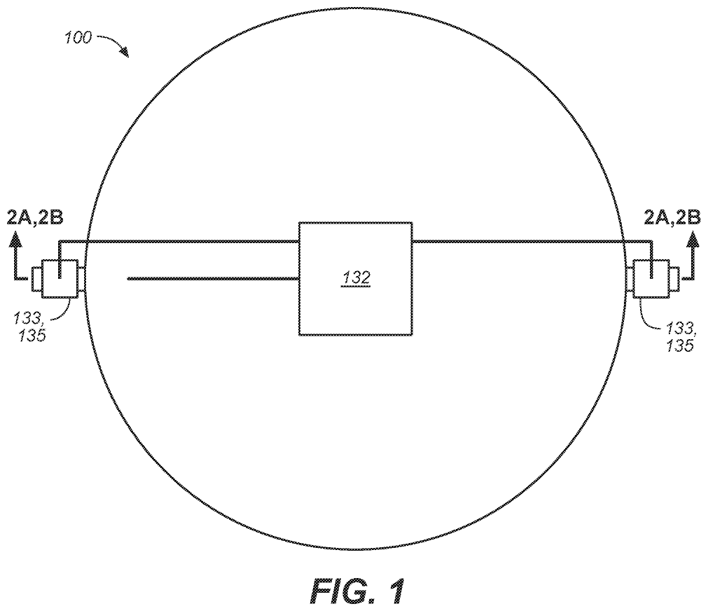

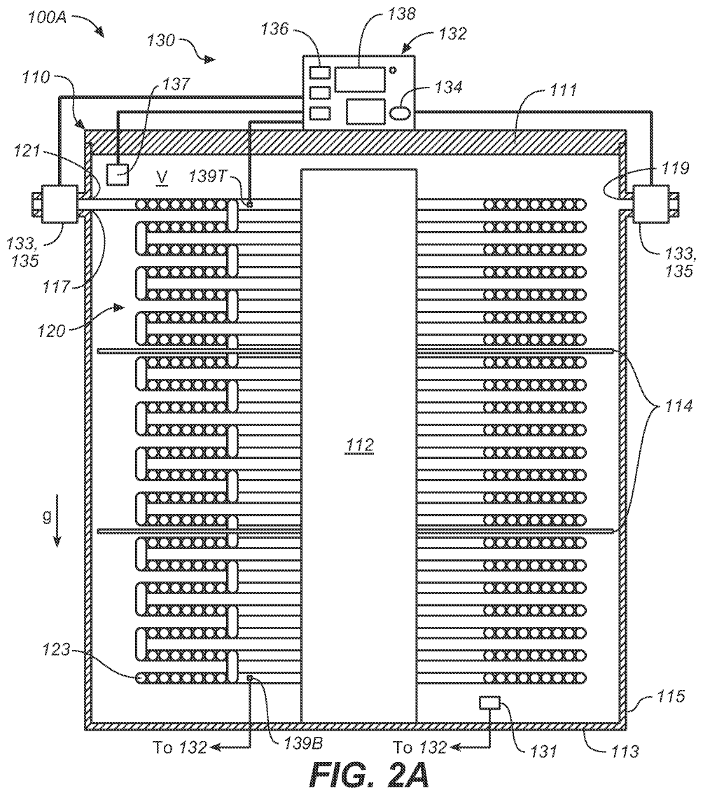

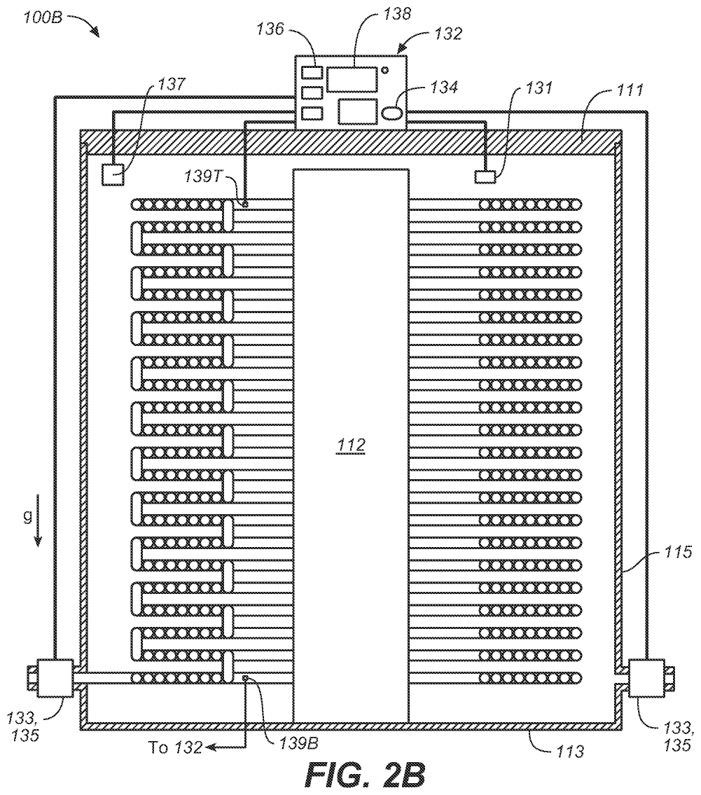

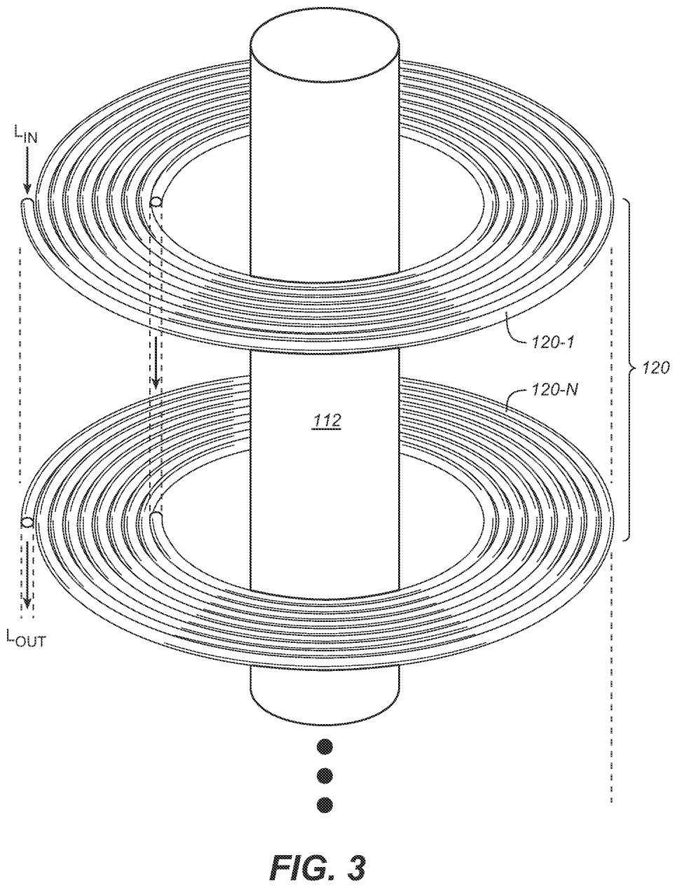

FIG. 1 is a top view of a heat exchanger 100 of the present invention, FIG. 2A is a sectional view 2A-2A of certain embodiments of the heat exchanger of FIG. 1, shown as heat exchanger 100A, and FIG. 3 is a perspective and sectional exploded view of the heat exchanger of FIG. 1. Heat exchanger 100A includes a container 110, a tube 120, and a control system 130. Container 110 includes, for example and without limitation, a top 111 relative to gravity g, a bottom 113, and a wall 115, which is shown for illustrative but not limited purposes as being a cylindrical wall. Container 110 has an interior volume V with a first opening 117 and a second opening 119 though container 110. FIG. 2A shows, for example and without limitation, first opening 117 and second opening 119 through wall 115, at a location near top 111. In certain embodiments, volume is from, for example and without limitation, be 1 liter or less, or may be hundreds of liters or more. In certain embodiments, container 110 is formed from plastic, including but limited to polypropylene, or from metal, including but not limited to stainless steel, or from a combination of plastic or metal.

Volume V may optionally also include elements such as a column 112 and/or baffles 114. Column 112 may be either a tube or a solid element is formed be made from the same material as container 110, or may be another material. The purpose of column 112 is to occupy space in volume V to affect the flow of liquid past tube 120. Baffles 114 are one or more plates that extend from column 112 to near the inside surface of wall 115. Baffles 114 are formed from the same material as container 110, or may be another material.

Tube 120 extends from near top 111 to near bottom 113, with a first tube end 121 at first opening 117 and a second end 123 within volume V. As described subsequently, first opening 117, second opening 119, and tube 120 may be used to introduce a liquid in one of the first and second openings, through the tube, and to remove the liquid from the other of the openings. As illustrated in FIG. 3, tube 120 may, in certain embodiments, be formed from layers of tubing, shown as layers 120-1, . . . , 120-N, which are coupled to direct the flow from a liquid input Lᵢₙ to liquid output Lₒᵤₜ. In one embodiment, tube 120 is substantially formed from metal tubing, such as stainless steel or other metal. In another embodiment, tube 120 is substantially formed from a plastic, such as, for example polypropylene, polyethylene, or any other suitable plastic material.

Control system 130 includes a heating element 131, a first pump 133 to provide liquid into the heat exchanger, a second pump 135 to remove liquid from the heat exchanger, a liquid level sensor 137, and a temperature sensor 139, shown for example as being one of temperature sensor 139A, located near first tube end 121, or a temperature sensor 139B, located second tube end 123, where each of these components are in communication with a controller 132. Heating element 131, for example and without limitation, generates heat from electric power and is as for example stainless steel cartridge heating elements as is known in the art, or externally heated element or coil. In various embodiments, the wiring between controller 132, heating element 131, and temperature sensor 139 may be outside of system wall 115 or within the center column 112.

Various embodiments include both first pump 133 and second pump 135, using or including only one of the first pump or the second pump. First pump 133 and second pump 135 may be, for example and without limitation a brushless diaphragm pump, as is known in the art. If the liquid is pressurized, then pumps may not be required, and solenoid valves may be used to control fluid flow through heat exchanger 100.

Controller 132 has computer memory and a processor that is programmed to maintain a flow of liquid through heat exchanger 100A. In certain embodiments, controller 132 is a temperature control device, such as a PID or a thermostat, which accepts outputs from level sensor 137, and one of temperature sensors 139A or 139B, and provides signals to operate the first and second pumps 133 and 135 and heating element 131. In general, heat exchanger 100 may operate with a temperature sensor 139 located within and near the portion of the tube where the liquid is hottest. Given specific configurations, only one temperature sensor is required, which may be temperature sensor 139B or 139T. Controller 132 also includes a power cord (not shown) to accept power from the mains, an on/off switch 134, buttons 136 for setting a set temperature, Tₛ, a minimum temperature, Tₘᵢₙ, and a maximum temperature, Tₘₐₓ, and a temperature readout 138.

In various embodiments, temperature sensor 139 may be for example and without limitation, a thermocouple, such as a k-type thermocouple, or a heat sensor such as an infrared sensor. In certain embodiments temperature sensor 139 is positioned to measure the temperature of the fluid within tube 120, and may be inserted through a hole in the tube or by a connector. In various other embodiments, level sensor 137 is located hear near top 111, and is for example and without limitation, a capacitance proximity sensor.

Certain other embodiments of heat exchanger 100 are illustrated as heat exchanger 100B, with reference to FIGS. 1 and 3, and FIG. 2B, which is a sectional view 2B-2B of heat exchanger 100B. Heat exchanger 100B is similar to heat exchanger 100 or 100A, except as explicitly stated.

Heat exchanger 100B is configured upside down from heat exchanger 100A. Thus, for example: container 110 of heat exchanger 100B has first opening 117 in wall 115 and second opening 119 in wall located near bottom 113; and tube 120 of heat exchanger 100B extends from near bottom 113 to near top 111.

In other alternative embodiments: one of first opening 117 or second opening 119 is located in wall 115 near bottom 113 and the other opening is located in the wall near top 111; and/or one or more of first opening 117 or second opening 119 is located through top 111 or through bottom 113.

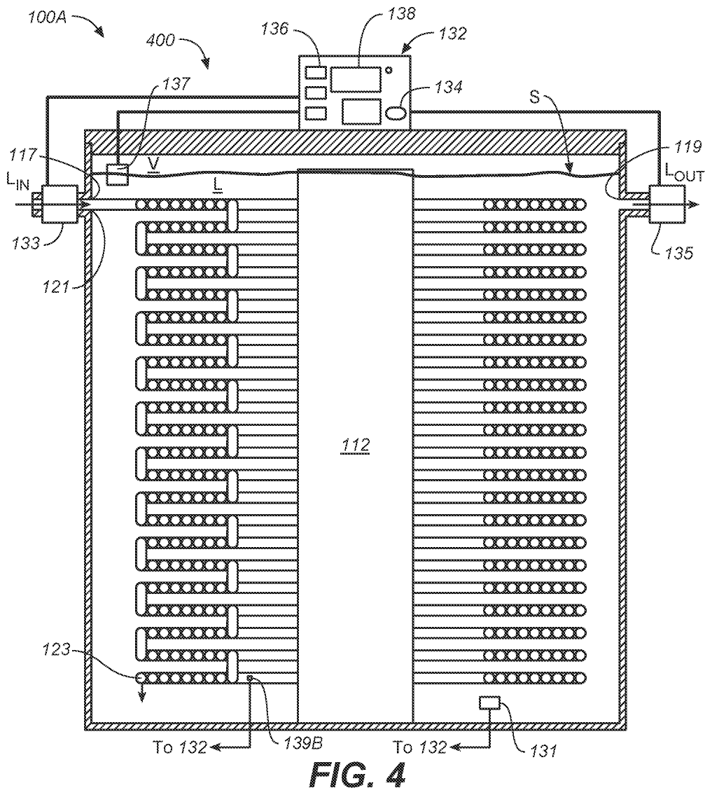

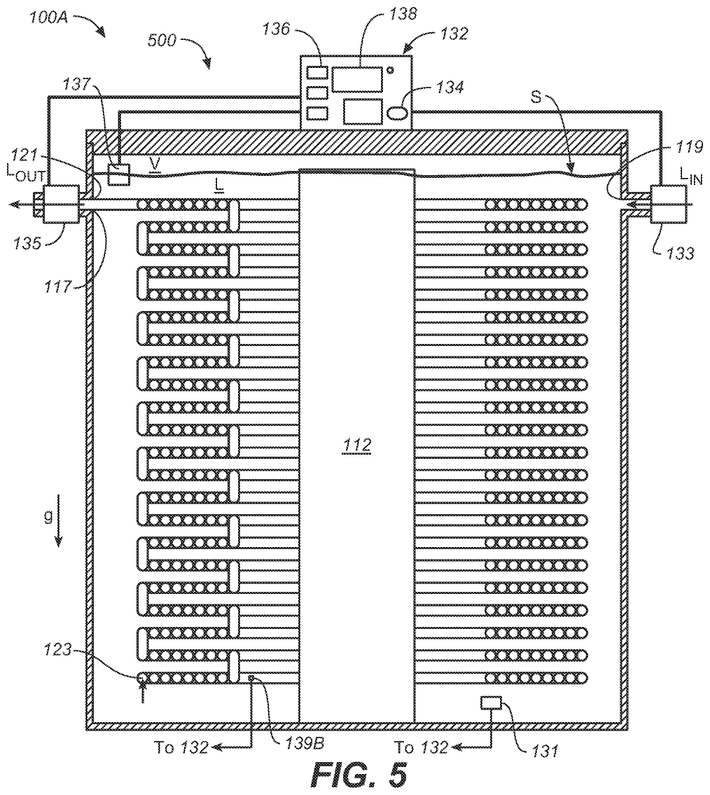

In general, heat exchanger 100 may be operated to heat a liquid by providing the liquid through either first opening 117 or second opening 119, as illustrated, for example and without limitation, in FIGS. 4 and 5. FIG. 4 is sectional view 400 of a first embodiment operation of the heat exchanger of FIG. 2A with first opening 117 being liquid inlet Lᵢₙ and second opening 119 being liquid outlet Loin, and where the heat exchanger includes temperature sensor 139B to control the heat exchanger.

One use of heat exchanger 100 is to sterilize targeted pathogens in a liquid by heating the liquid to a specified temperature for a specified amount of time. In general, as is known in the field, sterilization occurs when liquid is heated to a certain temperature, Tₚₐₛₜ, for a pasteurization time, tₚₐₛₜ, which is also referred to in the literature as the “Thermal Death Time” Thus, for example, the following table has been developed by the dairy industry lists the pasteurization temperature, Tₚₐₛₜ, and the corresponding pasteurization time at the pasteurization temperature, tₚₐₛₜ, to obtain a certain level of pasteurization (the “pasteurization type”) to destroy pathogens in milk. Table I may also be used to determine the heating temperature and time required to destroy pathogens in a contaminated liquid, such as water.

TABLE I
Pasteurization Requirements

| Pasteurization | Pasteurization | | |
|---|---|---|---|
| Temperature, Tₚₐₛₜ | Time, tₚₐₛₜ | | Pasteurization Type |
| 63° C. (145° F.) | 30 | minutes | Vat Pasteurization |
| 72° C. (161° F.) | 15 | seconds | High temperature short time |
| | | | Pasteurization (HTST) |
| 72° C. (161° F.) | 15 | seconds | High temperature short time |
| | | | Pasteurization (HTST) |
| 89° C. (191° F.) | 1.0 | second | Higher-Heat Shorter Time (HHST) |
| 90° C. (194° F.) | 0.5 | seconds | Higher-Heat Shorter Time (HHST) |
| 94° C. (201° F.) | 0.1 | seconds | Higher-Heat Shorter Time (HHST) |
| 96° C. (204° F.) | 0.05 | seconds | Higher-Heat Shorter Time (HHST) |
| 100° C. (212° F.) | 0.01 | seconds | Higher-Heat Shorter Time (HHST) |
| 138° C. (280° F.) | 2.0 | seconds | Ultra-Pasteurization (UP) |

In another embodiment the operation of heat exchanger 100A as shown if FIG. 4 is as follows. Prior to the operation of heat exchanger 100A, controller 132 is turned on and set temperature, Tₛ, which is the pasteurization temperature, Tₚₐₛₜ, minimum temperature, Tₘᵢₙ, and maximum temperature, Tₘₐₓ, are input using buttons 136. Initially, controller 132 provides no power to heating element 131 and operates pump 133 to provide the liquid into the first tube end 121. Eventually the liquid fills up the volume until level sensor 137 is reached. Once controller 132 determines that the liquid has reached the level sensor, the controller provides power to heating element 131 and turns off pump 133. When the temperature as measured by temperature sensor 139B reaches set temperature, Tₛ, controller 132 turns on pumps 133 and 135, and a properly treated liquid will exit the heat exchanger, where pump 133 provides ambient liquid into the heat exchanger and pump 134 removes processed liquid from the heat exchanger.

At this point in time, heat exchanger 100A is in a quasi-steady-state mode where the temperature measurement is used to control the pumps to provide a flow of pasteurized liquid from the heat exchanger.

In one embodiment, a calculation is performed to relate the time at temperature to the flow rate through tube 120. Thus, for example, if tube 120 has a diameter, d, and if each layer, n, includes a length of L of tube 120, then each tube layer contains a volume V=Lπd²/4. If the pumped volumetric flow rate is f, then the liquid spends t₁=V/f=Lπd²/(4f) in each layer. If it is further assumed that all of the liquid in the tube 120 layer near the temperature sensor 139B or 139T is at the measured temperature, Tₘₑₐₛ, then the liquid is assumed to be at temperature Tₘₑₐₛ fora time t₁.

In one embodiment, controller 132 is programmed to operate pumps 133 and/or 135 in the quasi-steady-state mode at an average flow rate, f, which provides for a time, t₁, which is larger than any expected pasteurization time, Tₚₐₛₜ given the volume. In another embodiment, controller 132 is programmed to operate pumps 133 and/or 135 in the quasi-steady-state mode at a variable flow rate to maintain a stable temperature around the heat source. All embodiments maintain that the maximum flow rate, fₘₐₓ, will not exceed the expected pasteurization time, Tₚₐₛₜ given the volume.

Controller 132 operates pumps 133 and/or 135 by turning the pumps on when the Tₘₑₐₛ is equal to or greater than Tₛ, and by turning the pumps off when Tₘₑₐₛ is less than Tₘᵢₙ. In addition, if the measured temperature reaches Tₘₐₓ, which may be the boiling point, controller 132 will, as a safety measure, turn heating element 131 turn off.

FIG. 5 is a sectional view 500 of a second embodiment operation of the heat exchanger of FIG. 2A with second opening 119 being liquid inlet Lᵢₙ and the first opening 117 being liquid outlet Lₒᵤₜ, and where the heat exchanger includes temperature sensor 139B to control the heat exchanger. The operation shown in FIG. 5 is generally the same as the operation discussed with reference to FIG. 4, except as explicitly noted.

When controller 132 is turned on and set temperature, Tₛ, minimum temperature, Tₘᵢₙ, and maximum temperature Tₘₐₓ, are provided using buttons 136, controller 132 first provides no power to heating element 131 and operates pump 133 to provide the liquid into volume V and the liquid will eventually flow into second tube end 123 and into tube 120. Eventually the liquid fills up tube 120 and the volume until level sensor 137 is reached. Once controller 132 determines that the liquid has reached the level sensor, the controller provides power to heating element 131 and turns off pump 133. Eventually, the temperature as measured by temperature sensor 139B will reach set temperature, Tₛ, at which time controller 132 turns on pumps 133 and 135, and a properly treated liquid will exit the heat exchanger. Controller 132 then operates heat exchanger 100B in the quasi-steady-state mode as described above.

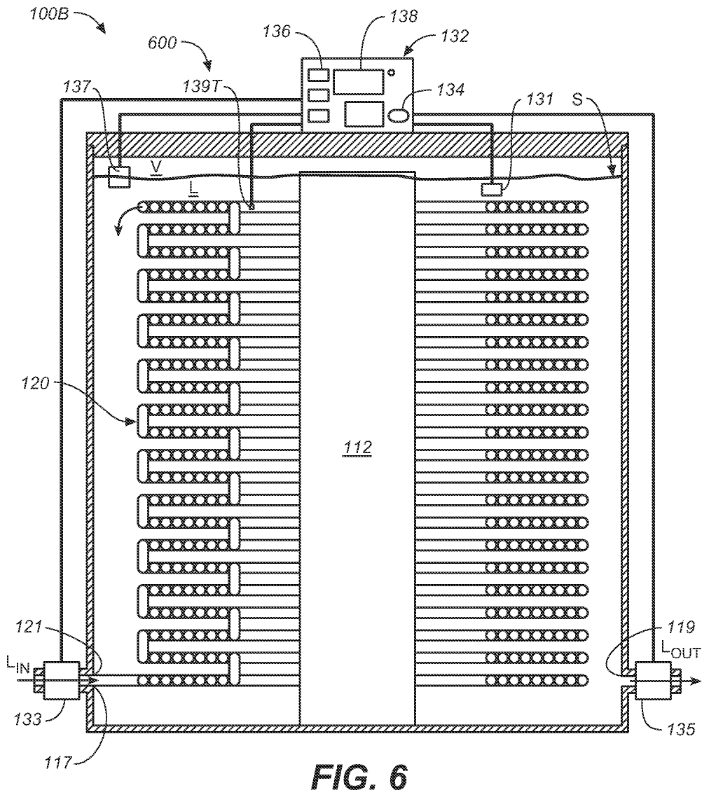

FIG. 6 is a sectional view 600 of a third embodiment operation of the heat exchanger of FIG. 2B with the first opening 117 being a liquid inlet Lᵢₙ and second opening 119 being liquid outlet Lₒᵤₜ. The operation shown in FIG. 6 is generally the same as the operation discussed with reference to FIGS. 4 and 5, except as explicitly noted.

In the embodiment of FIG. 6, the output of temperature sensor 139T is provided to controller 132. When controller 132 is turned on and set temperature, Tₛ, minimum temperature, Tₘᵢₙ, and maximum temperature Tₘₐₓ, are provided using buttons 136, controller 132 first provides no power to heating element 131 and operates pump 133 to provide the liquid into tube 120 and into volume V. Eventually the liquid fills up volume V until level sensor 137 is reached. Once controller 132 determines that the liquid has reached the level sensor, the controller provides power to heating element 131 and turns off pump 133. Eventually, the temperature as measured by temperature sensor 139T will reach set temperature, Tₛ, at which time controller 132 turns on pumps 133 and 135, and a properly treated liquid will exit the heat exchanger. Controller 132 then operates heat exchanger 100B in the quasi-steady-state mode as described above.

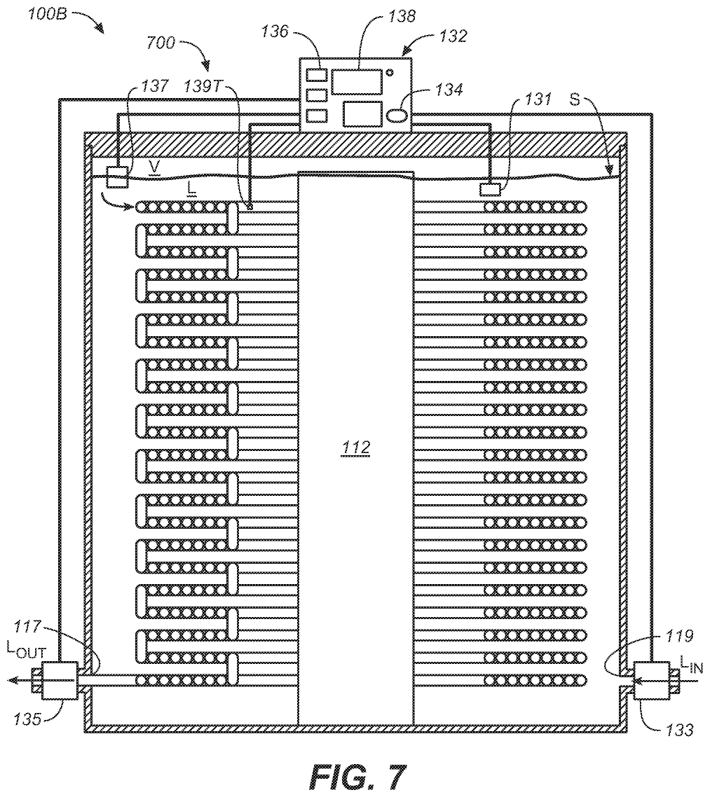

FIG. 7 is a sectional view 700 of a fourth embodiment operation of the heat exchanger of FIG. 2B with second opening 119 being liquid inlet Lᵢₙ and the first opening 117 being liquid outlet Lₒᵤₜ. The operation shown in FIG. 7 is generally the same as the operation discussed with reference to FIGS. 4-6, except as explicitly noted.

In the embodiment of FIG. 7, the output of temperature sensor 139T is provided to controller 132. When controller 132 is turned on and set temperature, Tₛ, minimum temperature, Tₘᵢₙ, and maximum temperature Tₘₐₓ, are provided using buttons 136, controller 132 first provides no power to heating element 131 and operates pump 133 to provide the liquid into tube 120 and into volume V. Eventually the liquid fills up volume V until level sensor 137 is reached. Once controller 132 determines that the liquid has reached the level sensor, the controller provides power to heating element 131 and turns off pump 133. Eventually, the temperature as measured by temperature sensor 139T will reach set temperature, Tₛ, at which time controller 132 turns on pumps 133 and 135, and a properly treated liquid will exit the heat exchanger. Controller 132 then operates heat exchanger 100B in the quasi-steady-state mode as described above.

One embodiment of each of the methods described herein is in the form of a computer program that executes on a processing system, e.g., one or more processors or control circuit. Thus, as will be appreciated by those skilled in the art, embodiments of the present invention may be embodied as a method, an apparatus such as a special purpose apparatus, an apparatus such as a data processing system, or a carrier medium, e.g., a computer program product. The carrier medium carries one or more computer readable code segments for controlling a processing system to implement a method. Accordingly, aspects of the present invention may take the form of a method, an entirely hardware embodiment, an entirely software embodiment or an embodiment combining software and hardware aspects. Furthermore, the present invention may take the form of carrier medium (e.g., a computer program product on a computer-readable storage medium) carrying computer-readable program code segments embodied in the medium. Any suitable computer readable medium may be used including a magnetic storage device such as a diskette or a hard disk, or an optical storage device such as a CD-ROM.

It will be understood that the steps of methods discussed are performed in one embodiment by an appropriate processor (or processors) of a processing (i.e., computer) system executing instructions (code segments) stored in storage. It will also be understood that the invention is not limited to any particular implementation or programming technique and that the invention may be implemented using any appropriate techniques for implementing the functionality described herein. The invention is not limited to any particular programming language or operating system.

Reference throughout this specification to “one embodiment” or “an embodiment” means that a particular feature, structure, or characteristic described in connection with the embodiment is included in at least one embodiment of the present invention. Thus, appearances of the phrases “in one embodiment” or “in an embodiment” in various places throughout this specification are not necessarily all referring to the same embodiment. Furthermore, the particular features, structures or characteristics may be combined in any suitable manner, as would be apparent to one of ordinary skill in the art from this disclosure, in one or more embodiments.

Similarly, it should be appreciated that in the above description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Thus, while there has been described what is believed to be the preferred embodiments of the invention, those skilled in the art will recognize that other and further modifications may be made thereto without departing from the spirit of the invention, and it is intended to claim all such changes and modifications as fall within the scope of the invention. For example, any formula given above is merely representative of procedures that may be used. Functionality may be added or deleted from the block diagrams and operations may be interchanged among functional blocks. Steps may be added or deleted to methods described within the scope of the present invention.

1. A heat exchanger having a fluid inlet to accept a fluid and a fluid outlet to provide a processed fluid, said heat exchanger comprising:
a container defining an exterior and an interior, where said container includes a first opening through said container and a second opening through said container, where one of said first opening or said second opening is the fluid inlet and where the other opening of said first opening and second opening is the fluid outlet;
a tube disposed within said container, where said tube has a first end and a second end, where said first end is attached to said first opening, and where said second end is within said interior of said container;
a heating element disposed in said container, and
a temperature sensor to measure a temperature of fluid within said tube or within said container,
where, when fluid inlet is provided with the fluid, the fluid flows through said tube, through said interior of said container, and through the fluid outlet.

2. The heat exchanger of claim 1, where said first opening is the fluid inlet, and where, when fluid inlet is provided with the fluid, the fluid flows, sequentially, from the fluid inlet at said first end of said tube to said second end of said tube, and through said interior of said container to the fluid outlet.

3. The heat exchanger of claim 1, where said second opening is the fluid inlet, and where, when fluid inlet is provided with the fluid, the fluid flows, sequentially, from the fluid inlet and into said interior of said container to said second end of said tube, and through said tube from said second end to said first end at the fluid outlet.

4. The heat exchanger of claim 1, where said container includes a top, a side, and a bottom, and where said first opening is an opening through said top, through said side, or through said bottom.

5. The heat exchanger of claim 1, where said container includes a top, a side, and a bottom, and where said second opening is an opening through said top, through said side, or through said bottom.

6. The heat exchanger of claim 1, further comprising:
one or more flow elements to control the flow of accepted fluid through said heat exchanger;
a liquid level sensor disposed in said container, and
a controller including a processor and memory and programmed to operate said one or more flow elements and said heating element in response to measurements of said temperature sensor and liquid level sensor.

7. The heat exchanger of claim 6,
where said one or more flow elements include a first pump to pressurize fluid entering said container at the fluid inlet and/or a second pump to provide suction to at the fluid outlet, or
where the accepted fluid is pressurized and where said one or more flow elements include one or more valves controllable to permit the pressurized fluid to flow through said heat exchanger.

8. The heat exchanger of claim 6, where said temperature sensor and said heating element are disposed near said top of said container.

9. The heat exchanger of claim 6, where said temperature sensor and said heating element are disposed near said bottom of said container.

10. The heat exchanger of claim 1, where said temperature sensor is within said tube.

11. A method of controlling a heat exchanger having a fluid inlet to accept a fluid and a fluid outlet to provide a processed fluid, where the heat exchanger includes: a container defining an exterior and an interior, where the container includes a first opening through the container and a second opening through the container, where one of the first opening or the second opening is the fluid inlet and where the other opening of the first opening and second opening is the fluid outlet; a tube disposed within the container, where the tube has a first end and a second end, where the first end is attached to the first opening, and where the second end is within the interior of the container; a heating element disposed in the container, and a temperature sensor to measure the temperature of fluid within the tube or within the container, where the heat exchanger further includes a controller including a processor and memory, where the processor is programmed to operate the one or more flow elements and the heating element in response to measurements of the temperature sensor and liquid level sensor.

12. The method of claim 11, where the one or more flow elements include a first pump to pressurize fluid entering the container at the fluid inlet and/or a second pump to provide suction to at the fluid outlet.

13. The method of claim 11, where the accepted fluid is pressurized and where the one or more flow elements include one or more valves controllable to permit the pressurized fluid to flow through the heat exchanger.

14. The method of claim 11, where the first opening is the fluid inlet, and where, when fluid inlet is provided with the fluid, the fluid flows, sequentially, from the fluid inlet at the first end of the tube to the second end of the tube, and through the interior of the container to the fluid outlet.

15. The method of claim 11, where the second opening is the fluid inlet, and where, when fluid inlet is provided with the fluid, the fluid flows, sequentially, from the fluid inlet and into the interior of the container to the second end of the tube, and through the tube from the second end to the first end at the fluid outlet.
